(19) United States
(12) Patent Application Publication
(10) Pub. No.: US 2018/0219209 A1
(43) Pub. Date: Aug. 2, 2018

(54) LITHIUM STORAGE BATTERY WITH INTEGRATED CIRCUIT-BREAKER FOR IMPROVED OPERATING SAFETY

(71) Applicant: COMMISSARIAT A L'ENERGIE ATOMIQUE ET AUX ENERGIES ALTERNATIVES, Paris (FR)

(72) Inventors: Frederic DEWULF, Voiron (FR); Pierre JOST, Vizille (FR)

(73) Assignee: COMMISSARIAT A L'ENERGIE ATOMIQUE ET AUX ENERGIES ALTERNATIVES, Paris (FR)

(21) Appl. No.: 15/747,647

(22) PCT Filed: Jul. 25, 2016
(86) PCT No.: PCT/EP2016/067683

§ 371 Date: Jan. 25, 2018

(30) Foreign Application Priority Data
Jul. 28, 2015 (FR) 1557191

(51) Int. Cl. H01M 2/34; H01M 2/02; H01M 2/26; H01M 2/12; H01M 10/0525; H01M 10/0587; H01M 4/66; H01M 4/70

(52) U.S. Cl. CPC H01M 2/345; H01M 2/022; H01M 2/027; H01M 2/0285; H01M 2/263; H01M 2200/20; H01M 10/0525; H01M 10/0587; H01M 4/661; H01M 4/70; H01M 2/1241

(57) ABSTRACT

The present invention relates to an electrochemical storage battery (A) containing lithium, comprising an electrochemical bundle (F), two current collectors, one of which is connected to the bundle anode and the other to the bundle cathode, and a housing (6) elongated along a central axis (X) and having a lid (9), a bottom (8) and a side casing (7) joined to both the bottom and the lid, the housing being designed to receive the bundle in a sealed manner, and some of the current collectors forming the poles (40, 50) extending through the housing. According to the invention, a circuit-breaker device is provided, which has a housing bottom wall that deforms in the plastic deformation range, as well as a rated breaking line provided around the central portion of the collector, which can tear in order to electrically separate said central portion, connected to the bottom, from the main external surface of the current collector, which is connected to one end of the electrochemical bundle.

### TECHNICAL FIELD

The present invention relates to the field of lithium electrochemical generators, which operate according to the principle of insertion or extraction, or in other words intercalation/deintercalation, of lithium in at least one electrode.

It relates more particularly to an electrochemical lithium battery having at least one electrochemical cell consisting of an anode and of a cathode on either side of a separator impregnated with electrolyte, two current collectors, of which one is linked to the anode and the other to the cathode, and a casing of a shape that is elongate along a longitudinal axis (X), the casing being designed to house the electrochemical cell in a sealtight manner while being passed through by a portion of the current collectors forming the output terminals, also referred to as poles.

The separator may consist of one or more films.

The casing may have a cover and a container, usually referred to as a can, or have a cover, a bottom and a lateral jacket joined both to the bottom and to the cover.

The present invention aims to produce a short-circuit safety device integrated into the battery.

“Abnormal operation of a battery” is understood to mean, in the context of the invention, battery usage conditions within an extreme current and/or temperature range that goes beyond the range of environmental conditions specified by the battery designer or manufacturer.

This may typically involve a case of overcharging a battery with currents greater than the specified nominal charging current, to a voltage threshold that is more often than not greater than the specified nominal voltage threshold. By way of example, this occurs above a voltage value of 3.6 V for an electrochemical pair of lithium iron phosphate LiFePO₄ (LFP) and graphite electrode materials, or above 4.2 V for the electrochemical pairs lithium cobalt oxide LiCoO2/graphite and LiNi_{0.33}Mn_{0.33}Co_{0.33}O₂ (NMC)/graphite.

This may also involve a case of deterioration of the performance of the battery due to the advanced ageing thereof beyond the limit recommended by the manufacturer and/or due to abnormal usage conditions, such as the exceedance of upper and lower voltage threshold limits, excessively high charging or discharging currents, extreme usage temperatures that are incompatible with the characteristics of the battery, etc.

### PRIOR ART

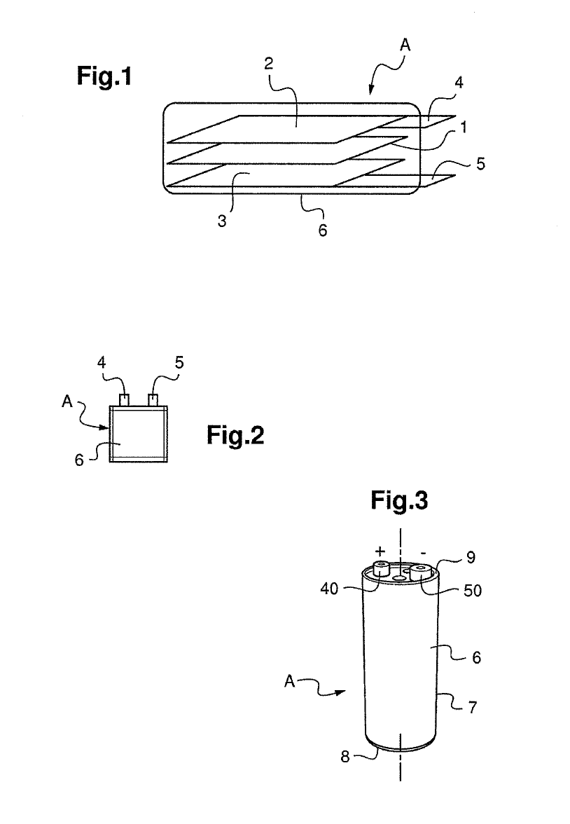

As illustrated schematically in FIGS. 1 and 2, a lithium-ion accumulator or battery usually has at least one electrochemical cell C consisting of a separator impregnated with a constituent electrolyte 1 between a positive electrode or cathode 2 and a negative electrode or anode 3, a current collector 4 connected to the cathode 2, a current collector 5 connected to the anode 3 and, lastly, a packaging 6 designed to contain the electrochemical cell in a sealtight manner while being passed through by a portion of the current collectors 4, 5 forming the output terminals.

The architecture of conventional lithium-ion batteries is an architecture that may be qualified as monopolar, as it has a single electrochemical cell having an anode, a cathode and an electrolyte. Several types of monopolar architecture geometry are known:
a cylindrical geometry such as disclosed in patent application US 2006/0121348;
a prismatic geometry such as disclosed in U.S. Pat. No. 7,348,098 and U.S. Pat. No. 7,338,733;
a stacked geometry such as disclosed in patent applications US 2008/060189 and US 2008/0057392 and U.S. Pat. No. 7,335,448.

The electrolyte constituent may be in solid, liquid or gel form. In the latter form, the constituent may comprise a separator made of a polymer or of a microporous composite imbibed with organic or liquid-ionic electrolyte(s) that enable(s) lithium ion to move from the cathode to the anode for a charge and vice versa for a discharge, thereby generating the current. The electrolyte is generally a mixture of organic solvents, for example of carbonates, to which a lithium salt, typically LiPF6, is added.

The positive electrode or cathode consists of lithium cation insertion materials that are generally composites, such as lithium iron phosphate LiFePO₄, lithium cobalt oxide LiCoO₂, optionally substituted lithium manganese oxide LiMn₂O₄ or a material based on LiNiₓMn_{y}Co_{z}O₂ where x+y+z=1, such as LiNi_{0.33}Mn_{0.33} Co_{0.33}O₂, or a material based on LiNiₓCo_{y}Al_{z}O₂ where x+y+z=1, LiMn₂O₄, LiNiMnCoO₂ or lithium nickel cobalt aluminum oxide LiNiCoAlO₂.

The negative electrode or anode very often consists of carbon, graphite or is made of Li₄TiO₅O₁₂ (titanate material), and also possibly based on silicon or based on lithium, or based on tin and alloys thereof, or of a silicon-based composite.

The anode and the cathode made of lithium insertion material may be deposited, using a conventional technique, in the form of an active layer on a metal sheet forming a current collector.

The current collector connected to the positive electrode is generally made of aluminum.

The current collector connected to the negative electrode is generally made of copper, of nickel-plated copper or of aluminum.

Conventionally, a Li-ion accumulator or battery uses a pair of materials at the anode and at the cathode that enable it to operate at a high voltage level, typically around 3.6 volts.

A Li-ion accumulator or battery has a rigid packaging or casing when the targeted applications pose a constraint whereby a long lifetime is sought, with for example very high pressures to be withstood and a requirement for a stricter level of sealtightness, typically less than 10⁻⁶ mbar·l/s helium, or in highly constrictive environments such as in the spatial or aeronautic field. The main advantage of rigid packagings is thus their high sealtightness, which is maintained over time on account of the fact that the casings are closed by welding, generally by laser welding.

The geometry of the majority of rigid casings for Li-ion battery packagings is cylindrical, as the majority of the electrochemical cells of the batteries are wound in a cylindrical geometry by spooling. Prism-shaped casings have also already been produced.

One of the types of cylinder-shaped rigid casing, usually manufactured for a high-capacity Li-ion battery with a lifetime of more than 10 years, is illustrated in FIG. 3.

The casing 6, with a central axis X, has a cylindrical lateral jacket 7, a bottom 8 at one end, and a cover 9 at the other end. The cover 9 bears the poles or terminals 40, 50 through which the current is output. One of the output terminals (poles), for example the positive terminal 40, is welded to the cover 9, whereas the other output terminal, for example the negative terminal 50, passes through the cover 9 with interposition of a seal (not shown) that electrically insulates the negative terminal 50 from the cover.

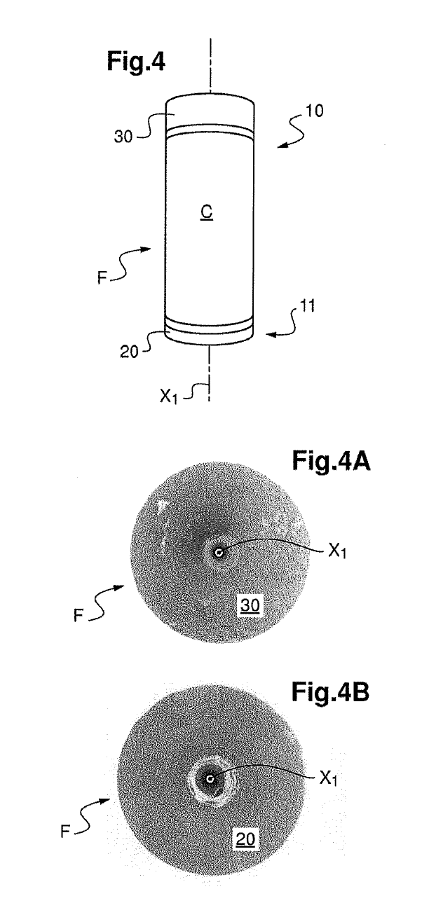

FIGS. 4 to 4B show reproductions of photographs of an electrochemical bundle F of a shape that is elongate along a central axis X1, and having a single electrochemical cell C such as is usually wound by spooling before the steps of housing in a casing and of electrical connection to the output terminals of the battery, and its impregnation with an electrolyte. The cell C consists of an anode 3 and of a cathode 4 on either side of a separator (not shown) suitable for being impregnated with the electrolyte. As is able to be seen in these FIGS. 4 to 4B, the bundle F has a cylindrical shape that is elongate along a longitudinal axis X1, with, at one 10 of its lateral ends, uncoated bands 30 of the anode 3, and, at the other 11 of its lateral ends, uncoated bands 20 of the cathode 2.

“Uncoated bands” is understood to mean, here and in the context of the invention, the portions of the metal sheets, also referred to as foils, forming the current collectors, that are not covered with a lithium insertion material.

Once the bundle has been produced, it is necessary to connect it to the two output terminals, of different polarity, of the battery.

The uncoated bands 20, 30 of the cathode 2 and of the anode 3 are thus bent, folded and/or compacted in order to obtain, at each end of the bundle, a base intended to be welded to a current collector.

One particularly advantageous method is disclosed in patent application WO 2015/044820 in the name of the applicant: this method combines folding with plastic deformation of at least some of the uncoated bands and axial compacting of these bands.

Once a base has been obtained at each end of the bundle, said base is mechanically and electrically linked to a current collector by welding.

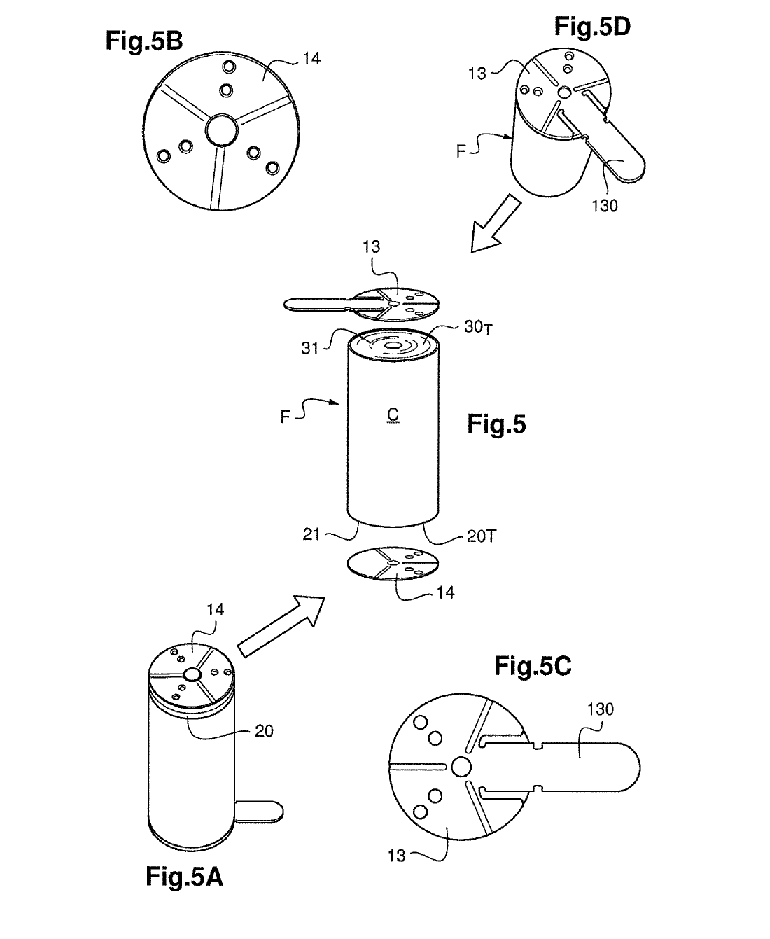

Thus, as illustrated in FIGS. 5, 5A and 5B, at one of the lateral ends 11 of the bundle, the base 21 formed by the compacted part 20T of the cathode (positive sides) is welded to a current collector 14, typically in the form of a solid disk, which disk is itself intended to be welded thereafter to the bottom 8 of the casing 6 of the battery.

At the other of the lateral ends 10 of the bundle, the base 31 formed by the compacted part 30T of the anode (negative sides) is welded in the same way to a conventional current-collector part 13 in the form of a solid disk pierced at the center thereof and a tab 130 projecting laterally from the disk 13 (FIGS. 5, 5C, 5D).

To complete the final production of the battery, the bundle with the collector 13 is inserted into a rigid container made of aluminum forming only the lateral jacket 7 of the casing 6 or forming a can consisting both of the lateral jacket 7 and of the bottom 8 of the casing 6. It is ensured in particular during this step that the tab 130 does not impede the insertion. To this end, said tab is advantageously folded upward.

The collector 14 is then welded to the bottom 8 of the casing 6.

The collector 13 is welded to a negative pole 50 forming a passage for a casing 6 cover 9.

The cover 9 is then welded to the rigid metal container 7.

Next, a step is performed of filling the casing 6 with an electrolyte, through a through-aperture (not shown) that is formed in the cover 9. The production of the Li-ion battery ends with the filling aperture being plugged.

One aim of battery manufacturers is to increase the autonomy of a cell forming the battery, or the ability thereof to be able to operate in high-power regimes while improving their lifetime, i.e. the number of times they are able to be cycled, their lightness and the costs of manufacturing these components.

Approaches to improving Li-ion batteries relate mainly to the nature of the materials and the methods for producing electrochemical-cell components.

Another possible approach for improvement relates to the safety of Li-ion batteries, it possibly being all the more important to ensure this safety for batteries with a high energy density.

The inventors have thus been prompted to design Li-ion batteries with a high capacity, typically a capacity of greater than 70 Ah, for a high specific energy, typically greater than or equal to 135 Wh/Kg, and an energy density that is also high, typically greater than or equal to 265 Wh/L.

A first approach could consist in replicating the rules for designing safety devices that are present in batteries with a lower capacity and/or a lower energy density, such as a safety seal enabling venting in the event of the internal pressure of the battery rising above a high threshold value, typically 15 bar.

Now, the inventors thought that the potentially high reactivity of a battery with a higher capacity, typically greater than 30 Ah, would require the implantation of additional protective means of the type that operate according to the principle of a short circuit that makes it possible to stop the flow of current in the event of internal overpressure that could possibly lead to a critical event, such as a battery explosion or fire.

The inventors therefore performed an inventory of all of the existing short-circuit safety devices in order to find out whether some of them could be reproduced or adjusted to their high-capacity and high-energy-density batteries.

Patent FR 2 977 379 discloses a battery the bottom of the container (casing) of which comprises a weakened part that breaks in the event of an overpressure brought about by internal gases in the battery. This patent indicates that the breakage of this weakened part interrupts the electrical connection between a deformable conductive membrane that is arranged against the bottom of the container. Now, there is a risk of the solution disclosed not working. Specifically, it is firstly necessary to ensure complete breakage of the weakened part over the entire periphery in order to effectively create the short circuit. Secondly, it is necessary to ensure that no contact (or restoration of contact) is possible between the deformable membrane and the bottom wall of the container at the weakened part. Now, that appears to be strongly questionable between these two conductive parts that are disclosed in this patent.

Patent EP 2270899 B1 and patent application US 2012/007062 each disclose a Li-ion battery the bottom of the container (casing) of which comprises a circular part breaks in the event of internal overpressure in the battery, the breakage of this circular part causing the venting of the gases and then the electrical disconnection between the bottom of the casing and the end of the electrochemical bundle opposite.

Patent application EP 1626456 also describes a Li-ion battery the wall of the bottom of the casing of which has a thinned zone, assumed to have a value of substantially equal to 20% of the thickness of the wall as stipulated in claim 11, so as to break in the event of internal overpressure in the battery and thus interrupt any electrical connection between said wall and the end of the electrochemical bundle opposite. Upon reading this document, one might question the reality of the disclosed short circuit operating, given the difficulty in obtaining the desired thinning and the difficulty in obtaining reproducibility.

All of the patent applications/patents above furthermore have major drawbacks that may be listed as follows:
in the event of a short circuit being performed effectively, restoration of current still remains possible from outside of the battery simply through contact on the lower central zone of the container, which goes against an indicated safety aim;
all of the solutions proposed mandatorily involve physically opening the casing and therefore the battery through venting, with inherent risks of electrolyte leakages and the evacuation of potentially toxic gases into the external environment.

There is therefore a need to improve the implementation of a short-circuit safety device for a lithium battery in the event of an overpressure of internal gases in the battery, in particular for the purpose of preventing, once the safety device has been tripped, any restoration of electrical contact (current) from outside the battery, and of avoiding venting from inside the battery at least until a certain internal overpressure value.

The aim of the invention is to at least partially meet this need.

### SUMMARY OF THE INVENTION

To this end, the invention relates, in one of its aspects, to an electrochemical lithium battery (A) having an electrochemical bundle (F) comprising at least one electrochemical cell (C) consisting of at least one anode and one cathode on either side of an electrolyte impregnated into a separator, two current collectors, of which one is linked to the anode and the other to the cathode, a casing of a shape that is elongate along a central axis (X), the casing having a cover, a bottom, a lateral jacket joined both to the bottom and to the cover, the casing being designed to contain the bundle in a sealtight manner while being passed through by a portion of the current collectors forming the poles.

According to the invention, the battery furthermore has:
a current collector in the form of a metal plate the central portion of which is welded to a central portion of the bottom about the axis (X), the collector bearing against the end of the electrochemical bundle, the peripheral portion around the central portion of the collector having a zone of smaller thickness forming a breakage initiation line;
at least one electrical insulation element, arranged between the plate forming the collector and the bottom of the casing opposite, around the central portions thereof, in order to electrically insulate said portions from one another.

According to the invention, the thickness of the bottom and the breakage initiation line are dimensioned such that, beyond a predetermined threshold value for the pressure prevailing inside the casing, the bottom undergoes a plastic deformation, preserving the weld between the central portion of the plate and that of the bottom, while generating a breakage of the initiation line, and thereby an irreversible electrical disconnection between the bundle and the bottom of the casing.

In other words, the invention consists in defining a short-circuit device with a casing bottom wall that deforms in the plastic range and at the same time a breakage initiation line, produced around the central portion of the collector, that is able to tear in order to electrically separate this central portion linked to the bottom of the casing from the main outer surface of the current collector, which surface is linked to an end of the electrochemical bundle.

The wall of the bottom of the casing thus deforms to an increasing extent as the internal pressure increases.

Once the disconnection has occurred, the wall of the bottom remains curved on account of its plastic deformation, and the current collector remains connected to the bottom as they are welded together via their central parts. By contrast, the bottom is detached and therefore electrically disconnected from the lower end of the electrochemical bundle F, the electrical insulation element(s) around the central portions moreover guaranteeing electrical insulation.

Once the short circuit according to the invention has been tripped, the safety of the battery is guaranteed, as it is no longer possible for a user to pass current between the two positive and negative terminals of the battery.

Furthermore, when the electrical circuit is broken, the battery remains sealed since, in contrast to the devices from the prior art, the bottom of the casing remains physically intact even though it has been plastically deformed.

According to one variant implementation, the battery comprises, as electrical insulation elements:
an annular spacer, preferably made of Kapton®, intercalated between the current collector and the bottom of the casing.
a plastic film surrounding the peripheral edge of the electrode foil.

The plastic film is advantageously made of a material chosen from polyimide (PI), polyetherimide (PEI), polypropylene (PP) or polyethylene (PE).

Alternatively, it is possible to provide an electrical insulation component covering both the peripheral edge of the electrode foil and the end of the bundle.

The remaining thickness in the breakage initiation line is preferably between 30 μm and 150 μm.

The thickness E of the wall of the bottom is again preferably between 0.5 and 2.0 mm for a bottom made of aluminum-based material.

The predetermined threshold value for the pressure beyond which the bottom of the casing undergoes a plastic deformation is advantageously greater than or equal to 5 bar.

The battery furthermore advantageously comprises a venting seal the opening of which is triggered as soon as the internal pressure reaches another predetermined threshold value, preferably greater than 15 bar.

The battery may be in the shape of a cylinder with a current collector in the shape of a disk with a thickness of preferably between 0.3 and 0.8 mm.

According to one advantageous feature, the casing and the current collector are made of an aluminum-based material.

According to one advantageous embodiment, the battery is configured to remain sealed after electrical disconnection between the current collector linked to the bundle and the bottom of the casing for an internal pressure level not exceeding a predetermined threshold value, preferably less than or equal to 12 bar.

According to one advantageous embodiment, the electrochemical bundle consists of a single electrochemical cell wound upon itself by spooling.

Preferably:
the material of the negative electrode(s) is chosen from the group including graphite, lithium, titanate oxide Li₄TiO₅O₁₂; or based on silicon or based on lithium, or based on tin and alloys thereof;
the material of the positive electrode(s) is chosen from the group including lithium iron phosphate LiFePO₄, lithium cobalt oxide LiCoO₂, optionally substituted lithium manganese oxide LiMn₂O₄ or a material based on LiNiₓMn_{y}Co_{z}O₂ where x+y+z=1, such as LiNi_{0.33}Mn_{0.33}Co_{0.33}O₂, or a material based on LiNiₓCo_{y}Al_{z}O₂ where x+y+z=1, LiMn₂O₄, LiNiMnCoO₂ or lithium nickel cobalt aluminum oxide LiNiCoAlO₂.

### DETAILED DESCRIPTION

Other advantages and features of the invention will become more clearly apparent on reading the detailed description of examples of implementation of the invention, given by way of non-limiting illustration with reference to the following figures, in which:

FIG. 1 is an exploded schematic perspective view showing the various elements of a lithium-ion battery,

FIG. 2 is a front view showing a lithium-ion battery with its flexible packaging according to the prior art,

FIG. 3 is a perspective view of a lithium-ion battery according to the prior art with its rigid packaging consisting of a casing;

FIG. 4 is a photographic perspective view of an electrochemical bundle of a lithium-ion battery according to the prior art, the bundle consisting of a single electrochemical cell wound upon itself by spooling;

FIG. 4A is a photographic top view of one lateral end of the electrochemical bundle according to FIG. 4;

FIG. 4B is a photographic top view of the other lateral end of the electrochemical bundle according to FIG. 4;

FIGS. 5 and 5A to 5D are photographic reproductions showing, in perspective and in a top view, each of the two current collectors welded to one of the lateral ends of an electrochemical bundle of a Li-ion battery;

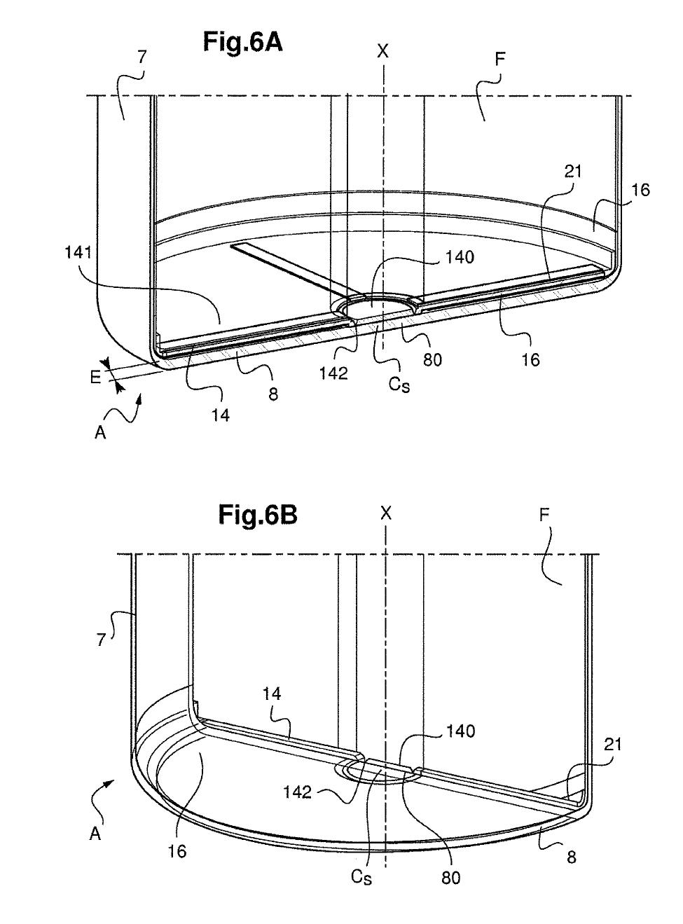

FIGS. 6A and 6B are longitudinal sectional and perspective views of the bottom of the casing of a lithium battery, these figures showing an example of a short-circuit safety device according to the invention in normal operation of the battery, that is to say without the safety device having been tripped;

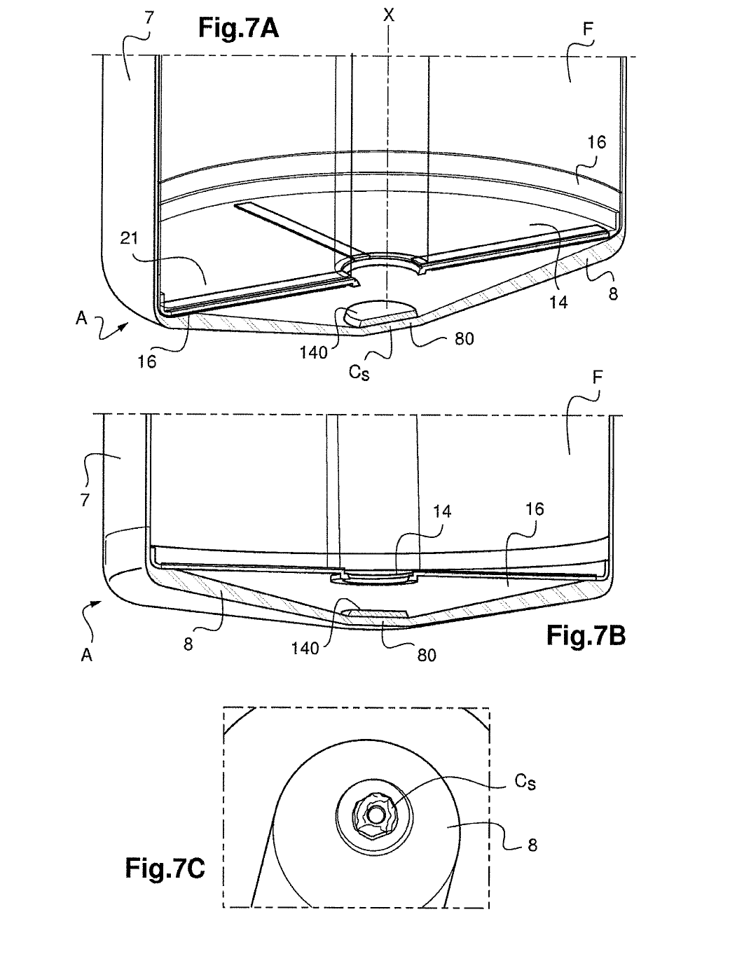

FIGS. 7A and 7B are longitudinal sectional and perspective views of the bottom of the casing of a lithium battery, these figures showing an example of a short-circuit safety device according to the invention once the safety device has been tripped;

FIG. 7C is a photographic view of the bottom of a casing of a Li-ion battery according to the invention, showing the weld bead between the central portion of the current collector according to the invention and the bottom of the casing;

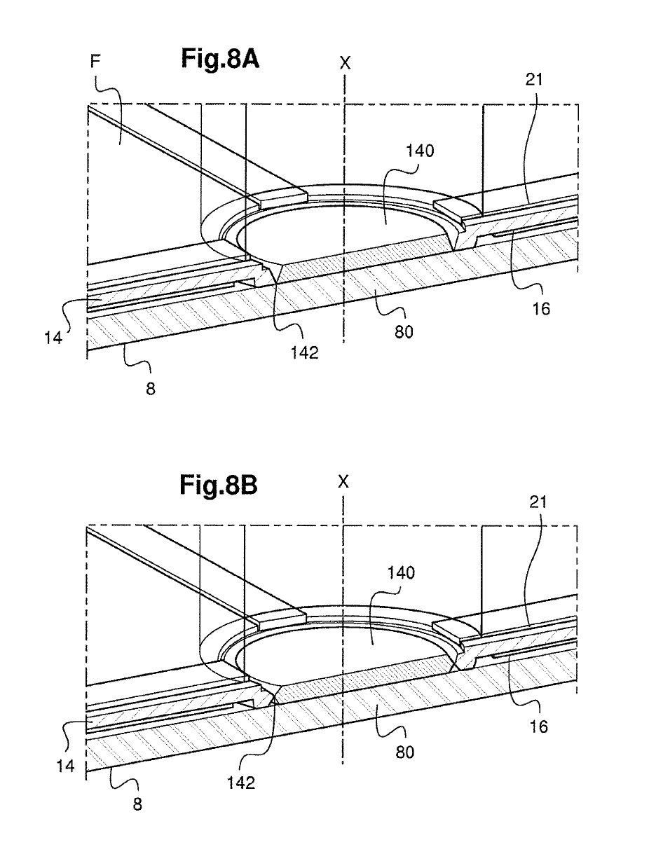

FIGS. 8A and 8B are detailed sectional and perspective views showing variant implementations of the breakage initiation line of the central part of the current collector according to the invention;

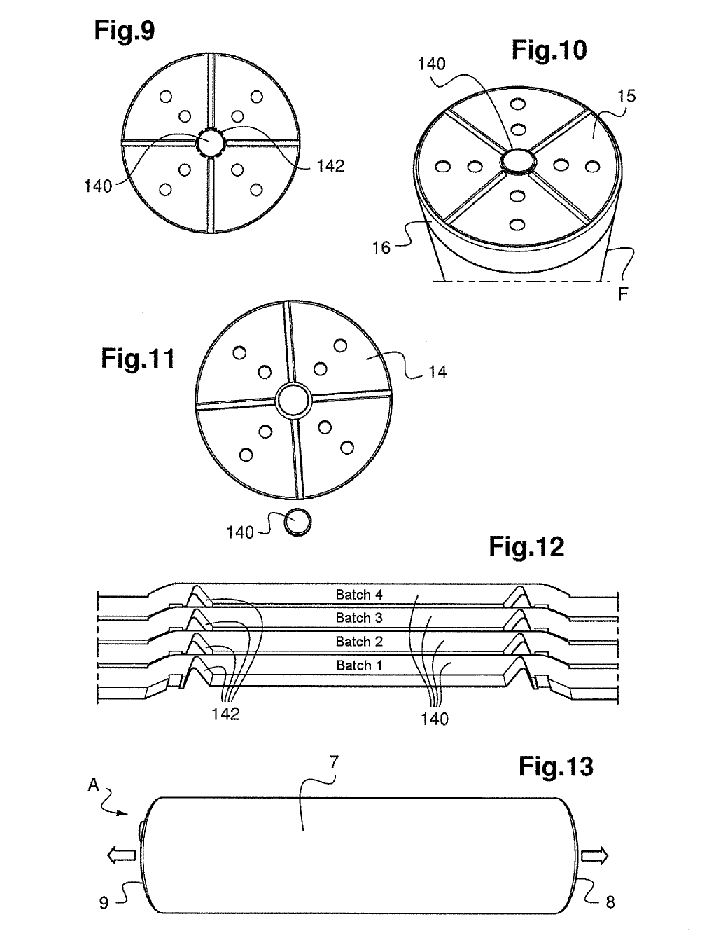

FIG. 9 is a photographic view of a current collector bearing on the bundle of a Li-ion battery according to the invention, showing the breakage initiation line according to the invention;

FIG. 10 is a photographic view showing electrical insulation elements installed according to the invention on the current collector at the bottom of the casing;

FIG. 11 is a photographic view showing the current collector according to FIG. 9 following the breakage of the central portion;

FIG. 12 is a photographic sectional view showing various batches of current collectors according to FIG. 9 with their respective breakage initiation line around their central portion;

FIG. 13 is a perspective view of a Li-ion battery with cylindrical geometry, with large dimensions, with a high energy density and a high capacity, the battery having been deformed under a rise in internal pressure to greater than a predetermined threshold value, equal to 16 bar in this case;

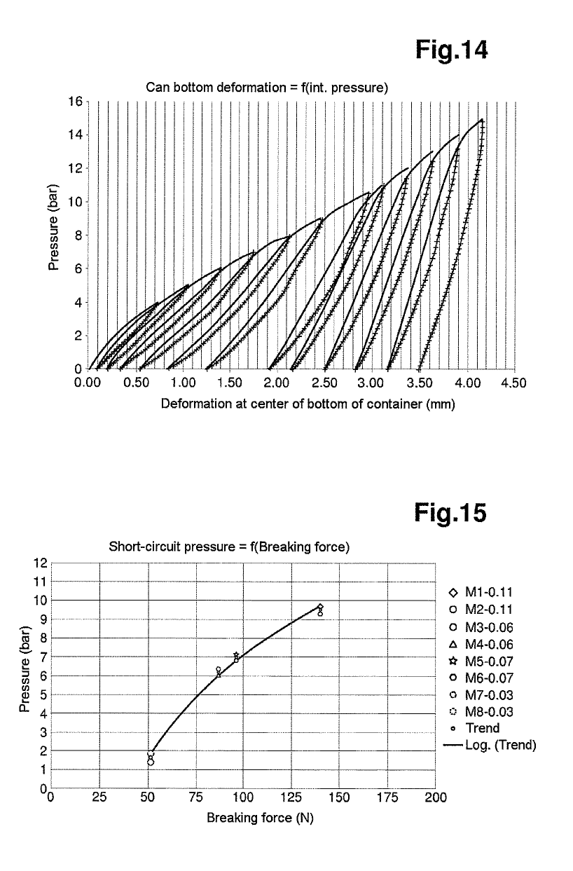

FIG. 14 illustrates, in the form of curves, the deformation undergone by a battery casing bottom according to the invention under the effect of the internal pressure;

FIG. 15 illustrates, in the form of curves, the positioning of the operating pressure of the short-circuit device according to the invention as a function of the average breaking force of the central portion that is weakened beforehand by its breakage initiation line;

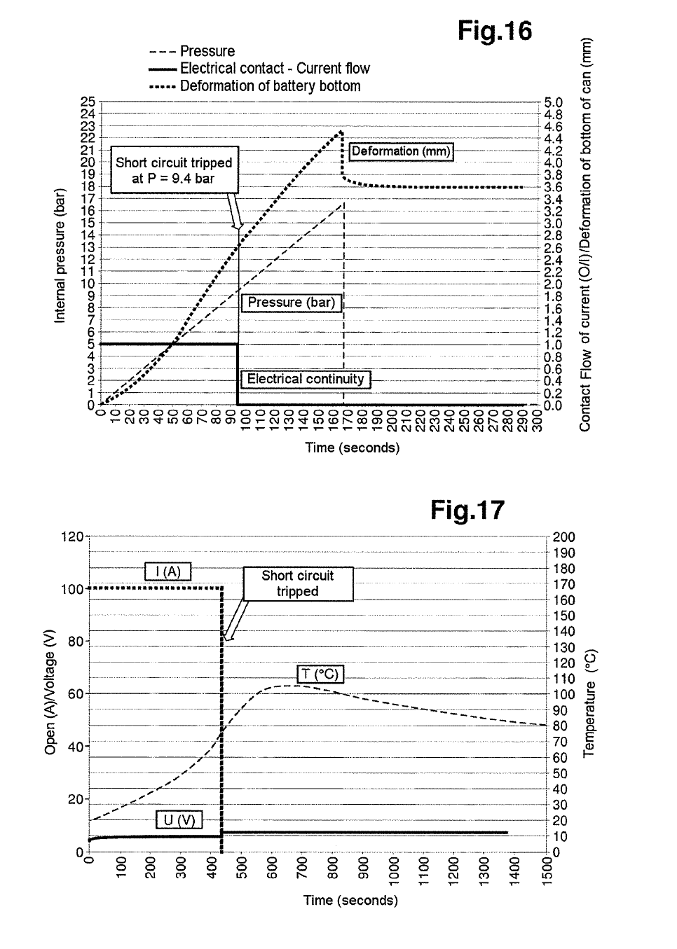

FIGS. 16 and 17 illustrate, in the form of curves, the voltage, the current and the temperature of a Li-ion battery with graphite/lithium iron phosphate LiFePO₄ electrodes, the battery having undergone an internal overpressure test that tripped the short-circuit device according to the invention.

For the sake of clarity, the same references denoting the same elements of a lithium-ion battery according to the prior art and according to the invention are used for all of FIGS. 1 to 11.

It will be noted that the various elements according to the invention are shown only for the sake of clarity and that they are not to scale.

FIGS. 1 to 5D have already been commented upon in detail in the preamble. They are therefore not described below.

The metal foils bearing the electrode materials may have a thickness of between 5 and 50 μm. For an anode foil 3, this may advantageously be a foil made of copper with a thickness of the order of 12 μm. For a cathode foil 2, this may advantageously be a foil made of aluminum with a thickness of the order of 20 μm.

In order to improve the operating safety of a Li-ion battery, in particular a battery with a high energy density and a high capacity, the inventors propose to integrate a new type of short-circuit device at the bottom of the battery casing.

One exemplary implementation of such a short circuit according to the invention integrated into a battery is shown in FIGS. 6A and 6B.

The bundle F according to the invention is therefore like the one shown in FIGS. 4 to 4B and has undergone, at each of these ends, at least one step of bending, folding and/or axial compacting of the electrode foils. Advantageously, the bundle F is produced in accordance with the method according to patent application WO 2015/044820.

The electrical connection steps and the sequence of these steps, between the electrochemical bundle F prepared with a base 21, 31 at each of its ends and the current collectors are performed essentially as described with reference to FIGS. 5 to 5D.

In particular, the current collector 13 at the anode 3 and its electrical and mechanical connection and welding to the end 31 of the bundle F may be identical to what is shown in FIGS. 5 to 5D. By way of example, the current collector 13 has a diameter Ø of between 1 and 10 cm, and a plate thickness e of between 0.2 and 1.2 mm.

The Li-ion battery according to the invention is distinguished from those of the prior art by a short-circuit device integrated on the bottom side 8 of the casing 6 that makes it possible to prevent, once it has been tripped, any restoration of electrical contact (current) from outside the battery, and to avoid venting from inside the battery at least until a certain internal overpressure value.

A description is given in relation to FIGS. 6A and 6B of the short-circuit device according to the invention, before it is tripped.

In contrast to the current collectors at the bottom of the battery casing according to the prior art, the current collector according to the invention in the form of a solid metal disk 14 is welded to the bottom 8 of the casing 6 only by its central portion 140. More precisely, this central portion 140 is welded to a central portion 80 of the bottom 8 about the central axis X of the battery. The disk 14 is preferably made of aluminum.

The collector 14 bearing against the end 21 of the electrochemical bundle.

The peripheral portion 141 around the central portion 140 of the collector furthermore has a zone of smaller thickness, forming a breakage initiation line 142.

The battery furthermore comprises at least one electrical insulation element 15, 16 arranged between the disk forming the collector 14 and the bottom of the casing opposite, around the central portions 80, 140 thereof, in order to electrically insulate said portions from one another.

Advantageously, as shown in FIG. 10, two electrical insulation elements are provided. One of these elements is in the form of a spacer 15, intended to be intercalated between the current collector 14 and the bottom of the casing. The other of these elements is an insulating film 16 surrounding the peripheral edge 20 of the cathode foil 2.

Another envisioned embodiment would consist in replacing the two elements, spacer 15 and insulating film 16, with a single insulation component so as to cover both the peripheral edge 20 of the cathode foil 2 and the end 21 of the bundle F.

According to the invention, both the thickness of the bottom 8 and the breakage initiation line 142 are dimensioned such that, beyond a predetermined threshold value for the pressure prevailing inside the casing, the bottom 8 undergoes a plastic deformation, preserving the weld between the central portion 140 of the plate and that 80 of the bottom, while generating a breakage of the initiation line, and thereby an electrical disconnection between the bundle and the bottom of the casing.

Thus, as described hereinafter, an electrical disconnection is obtained between the electrochemical bundle F and the bottom 8, and the electrical circuit of the battery is therefore cut.

The predetermined threshold value for the internal pressure of the battery may advantageously be equal to or greater than 5 bar, in particular between 5 and 10 bar.

When the casing 6, and therefore the bottom 8, is made of aluminum, the thickness E of the wall of the bottom 8 is preferably between 0.5 and 2.0 mm, so as to obtain therefrom a significant deformation in the plastic range, typically at least equal to 1 mm, within an internal pressure range of between 5 and 10 bar.

This bottom wall thickness range is advantageous as it is compatible with the customary methods for obtaining this component that is made of standard aluminum material, typically 1000 series, for example 1050, or 3000 series, for example 3003, by punching or using an impact extrusion technique.

The wall thickness of the collector 14 may be between 0.3 and 0.8 mm.

Preferably, and depending on the format of the battery, the mechanical resistance of the breakage initiation line 142 under a force applied to the center thereof will be between 30 N, which corresponds to a small-diameter battery format, typically of the order of 14 mm, and 140 N or more for battery formats with a diameter of greater than 60 mm.

The thickness of the breakage initiation line 1425 is preferably between 30 μm and 150 μm, depending on the area of the components under consideration.

The insulation component 15 is advantageously made from standard insulation material.

The insulating film 16 is advantageously made of plastic, such as of polyimide (PI), polyetherimide (PEI), polypropylene (PP) or polyethylene (PE).

A description is now given of the various modes of operation of a Li-ion battery according to the invention, depending on the tripping, or lack thereof, of the short-circuit device that has just been described.

During normal operation of the battery, the internal pressure remains low, at a pressure level of usually between 1 and 5 bar, throughout the entire usage lifetime of the battery.

The design of the casing 8 of the battery, and in particular of the thickness E of the bottom and of the breakage initiation line 142, takes into account a possible overpressure, typically of up to 4 bar, which may occur:
when the battery is stored, for example for an extended period at a high temperature, most often greater than or equal to +50° C.,
when the battery is cycled at high current regimes over temperature ranges that are also relatively high or low, typically at a low temperature of less than or equal to 0° C. or at a high temperature of greater than or equal to 50° C.: in charging and discharging phases, temperature rises may then occur and possibly be accompanied by generation of internal gas, depending on the nature of the electrochemical pair of the electrode materials used.

During abnormal operation of the battery, generation of internal gas exceeding 5 bar, and possibly reaching a level that is sometimes greater than 15 bar or more, may occur.

In the event of a high internal overpressure in the battery, typically an overpressure of greater than 5 bar, the wall of the bottom 8 of the container (casing) 6 deforms in the plastic range and significantly so, typically to a value of greater than 1 mm.

The desired plastic deformation is defined so as to obtain a breakage of the existing electrical link between the end 21 of the electrochemical bundle F, which is positive in the example illustrated, and the bottom 8.

In other words, the wall of the bottom 8 deforms in the plastic range, and at the same time the breakage initiation line is torn (broken).

As illustrated in FIGS. 7A and 7B, once this disconnection has occurred, the wall of the bottom 8 remains curved on account of its plastic deformation, and the current collector 14 remains connected to the bottom 8 as they are welded together via their respective central parts 80, 140.

By contrast, the bottom 8 is detached and therefore electrically disconnected from the lower end 21 of the electrochemical bundle F.

Electrical insulation is still guaranteed by the annular spacer 15 and/or the insulating plastic film 16.

As detailed hereinafter, the inside of the casing 8 may or may not remain under pressure. When it remains under pressure, this also contributes to maintaining the maximum deformation of the bottom 8.

Numerous variants may be provided for producing the breakage initiation line 142 in a circular manner 360° around the central portion 140. This initiation may be produced by machining or by an impact tool. The possible profiles may be a V-shaped profile (FIG. 8A) and/or a symmetrical double V-shaped profile (FIG. 8B).

Regardless of the profile selected, the weakening of the line 142 is dimensioned so as to guarantee 360° circular tearing when the wall of the bottom 8 deforms plastically and exerts a tractive force on the central portion 140 of the current collector 14.

FIG. 9 reproduces the bottom-view photograph of a collector showing the line 142 before it is broken.

FIG. 10 reproduces the insulating spacer made of Kapton® bearing against a current collector made of aluminum in the form of a disk 14.

FIG. 11 reproduces the photograph of the collector according to FIG. 9 with the central portion 140 that has been broken.

FIG. 12 shows various batches of collectors 14 produced with their respective breakage initiation line 142. In this illustrated example, the thicknesses of the weakened line 142 range from 30 μm for the smallest thickness (Batch 4) to 110 μm for the greatest thickness (Batch 1).

According to one advantageous embodiment, it is possible to provide a Li-ion battery with a safety ventilation seal in addition to the short-circuit device according to the invention that has just been described.

This ventilation seal is preferably produced on the cover 9 of the battery.

The safety seal is advantageously able to be opened within an internal overpressure range of 16+/−3 bar.

A description is now given of the various modes of operation of such a Li-ion battery according to the invention, depending on the tripping, or lack thereof, of the short-circuit device according to the invention and depending on the tripping, or lack thereof, of the additional ventilation seal.

During normal operation of the battery, that is to say when the internal pressure is lower than a predetermined threshold value typically equal to 5 bar, the wall of the bottom 8 of the casing undergoes little or no deformation.

Electrical conduction is guaranteed between the lower end 21 of the electrochemical bundle F and the bottom 8 connected by welding between the respective central parts 80, 140 of the bottom and of the connector 14.

In the event of a rise in internal pressure in a relatively short time, typically a rise in pressure over several minutes of operation, typically of the order of 15 to 20 minutes, the pressure is within a range of between 10 and 15 bar.

The plastic deformation of the bottom 8 of the casing 6 of the battery then occurs to an extent that is sufficient to enable the breakage of the line 142 and therefore the cutoff of electrical conduction between the end 21 of the electrochemical bundle F and the bottom 14, which moreover remains connected to the center of the bottom through the weld to the central part 140 of the latter.

The short-circuit device according to the invention is thus tripped. The safety of the battery is guaranteed, as it is no longer possible for a user to pass current between the two positive and negative terminals of the battery.

Furthermore, when the electrical circuit is broken, the battery remains sealed since, in contrast to the devices from the prior art, the bottom 8 of the casing remains intact even though it has been plastically deformed.

In the event of a rapid rise in internal pressure, typically an internal overpressure of 15 bar being reached in less than 1 minute, it is possible for the dynamics of the pressure rise to lead to an effect of simultaneous operation both of the short-circuit device according to the invention and of the safety ventilation seal.

In other words, in this case, tripping of the short circuit according to the invention at the bottom 8 of the casing 6 and opening of the safety ventilation seal occur simultaneously.

The safety of the battery is also guaranteed in this case, as it is no longer possible for a user to pass current between the two positive and negative terminals of the battery.

Furthermore, by opening the safety seal, the internal pressure of the battery falls back to atmospheric pressure.

FIG. 13 shows, by way of arrows in opposing directions, the deformation undergone respectively by the cover 9 and the bottom 8 of a Li-ion battery casing in the event of internal overpressure in the battery.

The inventors performed deformation tests on a casing bottom 8 of a cylindrical Li-ion battery according to the invention, under the effect of the pressure exerted inside the casing.

The dimensions of the battery casing on which the tests were performed are as follows: external diameter 65 mm and height 230 mm.

The results are shown in FIG. 14 in the form of curves.

It is seen from these curves that, for an internal pressure of the order of 12 bar, the deformation of the bottom 8 of the casing reaches around 3.4 mm.

The inventors performed other tests to validate the short-circuit device according to the invention that has just been described.

First of all, they placed the battery under pressure through the negative terminal, and then they applied a pressure rise ramp of 5 bar/min.

The electrical continuity signal between the two terminals is then recorded: if it is 1, current is flowing, if it is 0, the current is no longer flowing.

The results obtained are summarized in the table below:

| Number of | Average breaking | | |
|---|---|---|---|
| components - | force of | | |
| Weakening | the collector | | Deformation at |
| thickness | central zone | Pressure at short- | short-circuit |
| (mm) | (N) | circuit device (bar) | device (mm) |
| M1 - 0.11 | 140 | 9.50 | 2.66 |
| M2 - 0.11 | 140 | 9.30 | 2.78 |
| M3 - 0.06 | 87 | 6.60 | 1.88 |
| M4 - 0.06 | 87 | 6.00 | 1.75 |
| M5 - 0.07 | 96 | 7.00 | 2.55 |
| M6 - 0.07 | 96 | 7.27 | 2.3 |
| M7 - 0.03 | 51 | 1.7 | 0.23 |
| M8 - 0.03 | 51 | 1.8 | 0.25 |

From this table, it is seen that the components (M7 and M8) having the smallest weakening thickness lead to the lowest short-circuit tripping pressure result, and vice versa for the components (M1 and M2) with the greatest weakening thickness.

FIG. 15 illustrates the behavior when a pressure test is applied to the models M1 and M2: what is thus seen is the deformation of the bottom 8 of the battery until the opening of the safety seal at a pressure that is in this case measured at 16.5 bar.

FIG. 16 illustrates, in the form of curves, the evolution as a function of time, before and after tripping of the short circuit, of the deformation of the wall of the bottom 8 of a battery casing, of the pressure prevailing inside this casing and of the electrical continuity, or lack thereof, between the two positive and negative terminals of the battery, respectively. It is clearly seen in this FIG. 13 that tripping of the short-circuit device instantly brings about a breakage of the electrical connection between the terminals of the battery.

FIG. 17 illustrates, again in the form of curves, the evolution as a function of time of the current, of the voltage and of the temperature within the battery, respectively.

Other variants and improvements may be made without however departing from the scope of the invention.

Lastly, although the casing 6 in the illustrated embodiments that have just been described is made of aluminum, it may also be made of steel, or of nickel-plated steel. In such a variant, a casing made of steel or of nickel-plated steel forms the negative potential, the current collector 14 incorporating the short-circuit device according to the invention then forming a connection to the negative pole.

The invention is not limited to the examples that have just been described; it is in particular possible to combine features of the illustrated examples with one another in variants that have not been illustrated.

1. An electrochemical lithium battery (A) having an electrochemical bundle, comprising:
at least one electrochemical cell comprising at least one anode and one cathode on either side of an electrolyte impregnated into a separator;
two current collectors, of which one is linked to the anode and the other to the cathode;
a casing of a shape that is elongate along a central axis (X), the casing having a cover, a bottom, a lateral jacket joined both to the bottom and to the cover, the casing being designed to contain the bundle in a sealtight manner while being passed through by a portion of the current collectors forming poles;
a current collector in the form of a metal plate the central portion of which is welded to a central portion of the bottom about the axis (X), the collector bearing against the end of the electrochemical bundle, the peripheral portion around the central portion of the collector having a zone of smaller thickness forming a breakage initiation line; and
at least one electrical insulation element arranged between the plate forming the collector and the bottom of the casing opposite, around central portions thereof, in order to electrically insulate said portions from one another,
wherein the thickness of the bottom and the breakage initiation line are dimensioned such that, beyond a predetermined threshold value for the pressure prevailing inside the casing, the bottom undergoes a plastic deformation, preserving the weld between the central portion of the plate and that of the bottom, while generating a breakage of the initiation line, and thereby an irreversible electrical disconnection between the bundle and the bottom of the casing.

2. The electrochemical battery of claim 1, further comprising:
an annular spacer as electrical insulation element, intercalated between the current collector and the bottom of the casing.

3. The electrochemical battery of claim 1, further comprising:
a plastic film as electrical insulation element, surrounding a peripheral edge of electrode foil.

4. The electrochemical battery of claim 3, wherein the plastic film being made of at least one material selected from the group consisting of a polyimide, a polyetherimide, a polypropylene and a polyethylene.

5. The electrochemical battery (A) of claim 1, further comprising:
an electrical insulation component covering both a peripheral edge of electrode foil and an end (21) of the bundle.

6. The electrochemical battery of claim 1, wherein a remaining thickness in the breakage initiation line is between 30 μm and 150 μm.

7. The electrochemical battery of claim 1, wherein a thickness of the wall of the bottom is between 0.5 and 2.0 mm for a bottom made of aluminum-based material.

8. The electrochemical battery of claim 1, wherein predetermined threshold value for the pressure is greater than or equal to 5 bar.

9. The electrochemical battery of claim 1, further comprising:
a venting seal the opening of which is triggered as soon as the internal pressure reaches another predetermined threshold value.

10. The electrochemical battery of claim 1, having a shape of a cylinder with a current collector in the shape of a disk.

11. The electrochemical battery of claim 1, wherein the casing and the current collector are made of an aluminum-based material.

12. The electrochemical battery of claim 1, which is configured to remain sealed after electrical disconnection between the current collector linked to the bundle and the bottom of the casing for an internal pressure level not exceeding a predetermined threshold value.
